(19) United States
(12) Patent Application Publication
(10) Pub. No.: US 2015/0034541 A1
(43) Pub. Date: Feb. 5, 2015

(54) FLUID FILTER FOR AN INTERNAL COMBUSTION ENGINE

(71) Applicant: GM GLOBAL TECHNOLOGY OPERATIONS LLC, Detroit, MI (US)

(72) Inventors: Vincenzo COGNETTA, Torino (IT); Giuseppe Maccarrone, Torino (IT)

(21) Appl. No.: 14/447,305

(22) Filed: Jul. 30, 2014

(30) Foreign Application Priority Data
Jul. 30, 2013 (GB) 1313587.6

(51) Int. Cl. F01M 11/03; B01D 29/58; B01D 29/15; B01D 35/00

(52) U.S. Cl. CPC F01M 11/03; B01D 35/005; B01D 29/58; B01D 29/15
USPC 210/171; 210/323.2

(57) ABSTRACT

A fluid filter cartridge is disclosed for filtering lubricating oil. The fluid filter cartridge includes a first filter medium having a tubular shape defining a central conduit and a second filter medium occluding the central conduit.

### CROSS REFERENCE TO RELATED APPLICATION

This application claims priority to GB Patent Application No. 1313587.6 filed Jul. 30, 2013, which is incorporated herein by reference in its entirety.

### TECHNICAL FIELD

The technical field generally relates to a fluid filter for an internal combustion engine, and in particular to a filter cartridge for filtering lubricating oil.

### BACKGROUND

As known, the filtering of lubricating oil is generally obtained by means of a fluid filter which includes an external casing provided with an inlet for the fluid to be filtered and an outlet for the filtered fluid, and a filter cartridge, housed in the casing and suitable for dividing an internal volume of the casing into two distinct chambers, of which a first chamber communicating with a fluid inlet and a second chamber communicating with a fluid outlet.

A typical filter cartridge includes a tubular filter medium, for example a pleated filter medium or a depth medium, and two support plates which are fixed to the opposite ends of the filter medium. In this way, the fluid flowing from the fluid inlet towards the fluid outlet of the filter is forced to cross the filter medium, which retains the impurities that might be present therein.

During use, it can happen that the fluid to be filtered encounters an excessive hydraulic resistance flowing through the filter medium; as a consequence the fluid flow across the medium is extremely reduced. This can occur for example when the quantity of accumulated impurities has completely clogged the filter medium, or each time that, due to particular operating conditions, the fluid to be filtered reaches viscosity values that are very high, as happens in the case of filtration of oil when operating temperatures are very low. Indeed at low temperature the viscosity of oil increases and oil become denser, increasing its capability to collect and transport impurities into the lubricating circuit.

To obviate this problem, usually the filters are equipped with an automatic bypass valve which, following an increase in the fluid pressure, in the chamber of the fluid to be filtered, beyond a predetermined value, opens a direct passageway between the chamber of the fluid to be filtered and the chamber of the filtered fluid, bypassing the filter medium. In case of an oil filter the opening of the by-pass valve allows the oil to flow directly into the lubricating circuit by-passing the filter medium. As a consequences impurities in the oil flow in the lubricating circuit increasing the risk of damages to the engine lubricating components. The presence of impurities into the lubricating circuit can lead to serious damages to the engine lubricated components.

This situation is worse in the fluid filters, for instance oil filters, having a configuration which provides that the by-pass valve is located in a bottom region of the fluid filter casing. This is due to fact that impurities and dust have usually a specific weight greater than the one of the oil and therefore they tend to accumulate towards the bottom of the casing closed to the by-pass valve. As a consequence when the by-pass valve opens the quantity of impurities flowing in the lubricating circuit is greater.

To obviate this problem fluid filters are equipped with a second filter medium located upstream the by-pass valve. However, in conventional fluid filters, the second filter medium is fixed to the filter casing or directly to the by-pass valve and it is not usually replaced during maintenance of the engine. Therefore, it happens that the second filter medium occludes compromising the operating of the engine.

### SUMMARY

The present disclosure provides a fluid filter for an internal combustion engine and a fluid cartridge for the fluid filter, which are able to solve or at least positively reduce the above mentioned drawbacks of the prior art. The improved fluid filter cartridge and fluid filter is achieving in a simple, rational and rather inexpensive solution.

In particular, an embodiment of the present disclosure provides a fluid filter cartridge including a first filter medium having a tubular shape defining a central conduit and a second filter medium occluding the central conduit. This arrangement advantageously allows an easier and faster replacement of both the filter media, which are both provided in the same filter cartridge.

According to an aspect of the filter cartridge, the first filter medium is provided with an upper plate and a lower plate each plate having a central hole, and each hole being respectively in communication with an end of the central conduit. According to another aspect of the filter cartridge, a plurality of connecting elements connects the lower plate to the upper plate. These aspects of the filter cartridge have the advantage of improving the structural strength of the cartridge.

According to an aspect of the filter cartridge, the lower plate has an annular upper protruding flange protruding upwards from a rim of the central hole. This aspect of the filter cartridge allows the definition of valve seat for a valve member of a by-pass valve usually provided in fluid filter housing for a filter cartridge according to the present disclosure.

According to an aspect of the filter cartridge, the second filter medium has a cup-shaped body. This aspect of the filter cartridge allows an economic and reliable manufacturing of the second filter medium. Besides a cup shaped body filter medium guarantees a large filtering surface.

According to an aspect of the filter cartridge, the second filter medium has a protruding annular rim housed in an annular seat of the lower plate. This aspect of the filter cartridge allows reliable connection between the second filter medium and the lower plate of the filter cartridge.

Another embodiment of the present disclosure provides a fluid filter for an internal combustion engine including an external casing provided with an inlet for a fluid to be filtered and an outlet for the filtered fluid. A filter cartridge, such as described above, divides an internal volume of the casing into a first chamber communicating with a fluid inlet and a second chamber communicating with a fluid outlet. A by-pass valve is placed in the central conduit of the filter cartridge downstream the second filter medium. This embodiment of the fluid filter allows the filtration of a fluid, such as oil, also in operating condition of the engine requiring the opening of the by-pass valve.

According to an aspect of this embodiment the second chamber houses a hollow tubular element configured to be inserted in the central conduit of the filter cartridge. This embodiment of the fluid filter allows a reliable communication between the second chamber and the fluid outlet.

According to another aspect of this embodiment the hollow tubular element includes an upper portion provided with a plurality of bores. This aspect of the fluid filter allows the flowing of the filtered fluid towards the fluid outlet.

According to another aspect of this embodiment the hollow tubular element includes a lower portion housing the by-pass valve. This aspect of the fluid filter allows to realize in a simple and economic way the housing of the by-pass valve in the second chamber.

According to another aspect of this embodiment the by-pass valve includes a valve member and a valve seat, which is defined by an upper portion of the annular hollow flange of the lower plate. This aspect of the fluid filter guarantees a reliable and economic technical solution to realize the valve seat of the by-pass valve.

Another embodiment of the present disclosure provides an internal combustion engine equipped with a fluid filter according to the above disclosed embodiments. This embodiment allows the same advantages already disclosed for the previous embodiments.

### BRIEF DESCRIPTION OF THE DRAWINGS

The present disclosure will hereinafter be described in conjunction with the following drawing figures, wherein like numerals denote like elements.

FIG. 1 schematically shows an internal combustion engine provided with a lubricating circuit;

FIG. 2 is the section A-A of FIG. 1;

FIG. 3 schematically shows a sectional view of a fluid filter of the internal combustion engine;

FIG. 4 schematically shows a sectional view of a filter cartridge of the fluid filter; and

FIG. 5 is a larger view of a bottom portion of the fluid filter of FIG. 3.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

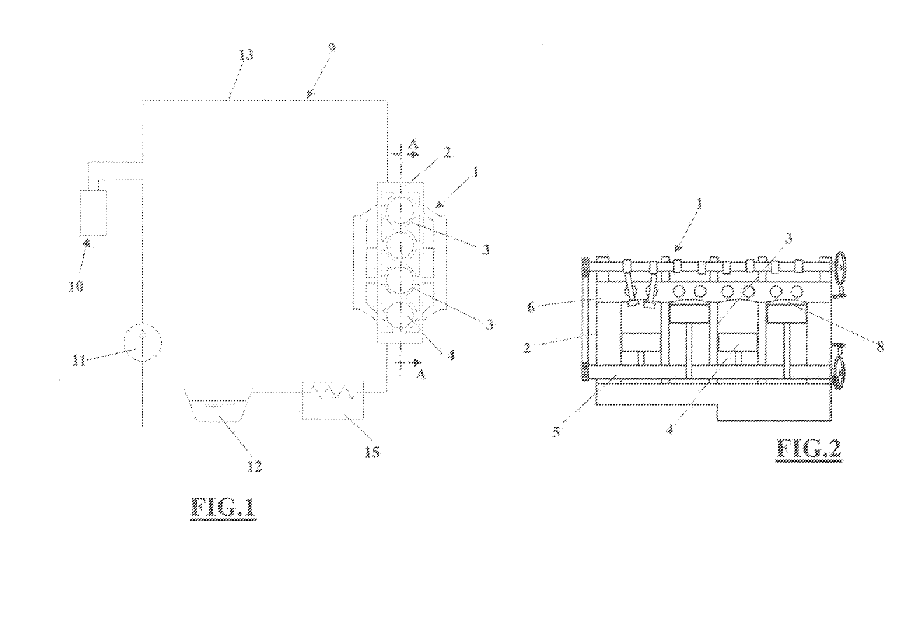

Some embodiments may include an internal combustion engine (ICE) 1, as shown in FIGS. 1 and 2, having an engine block 2 defining at least one cylinder 3 having a piston coupled to rotate a crankshaft 5. A cylinder head 6 cooperates with the piston to define a combustion chamber 8 wherein a mixture of air and fuel is injected for operating the engine.

The internal combustion engine 1 includes an engine lubricating circuit 9 for lubricating the rotating and sliding components of the ICE 1. The engine lubricating circuit 9 includes an oil pump 11 that draws lubricating oil from an oil sump 12 and delivers it, under pressure, through a plurality of lubricating channels 13 internally defined by the engine block 2 and by the cylinder head 6. The engine lubricating circuit 9 includes also a fluid filter, in particular an oil filter 10 for filtering impurities and dust in the oil avoiding the flowing of the same into the lubricating circuit 9.

The engine lubricating circuit 9 may also be equipped with an oil cooler 15 for cooling 15 down the oil, once it has passed through the lubricating channels 13 and before it returns to the oil sump 12. In particular, the lubricating channels 13 usually include a main oil gallery internally defined by the engine block 2, where the lubricating oil is directed towards a plurality of exit holes for lubricating many movable components of the ICE 1, before returning in the oil sump 12. These ICE movable components include, but are not limited to, crankshaft bearings (main bearings and big-end bearings), camshaft bearings operating the valves, tappets and the like.

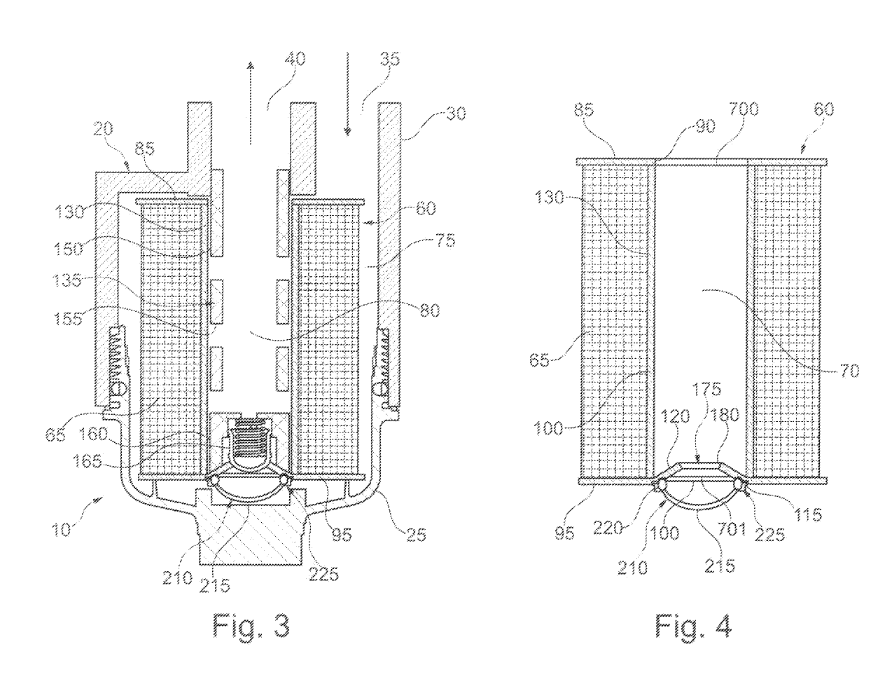

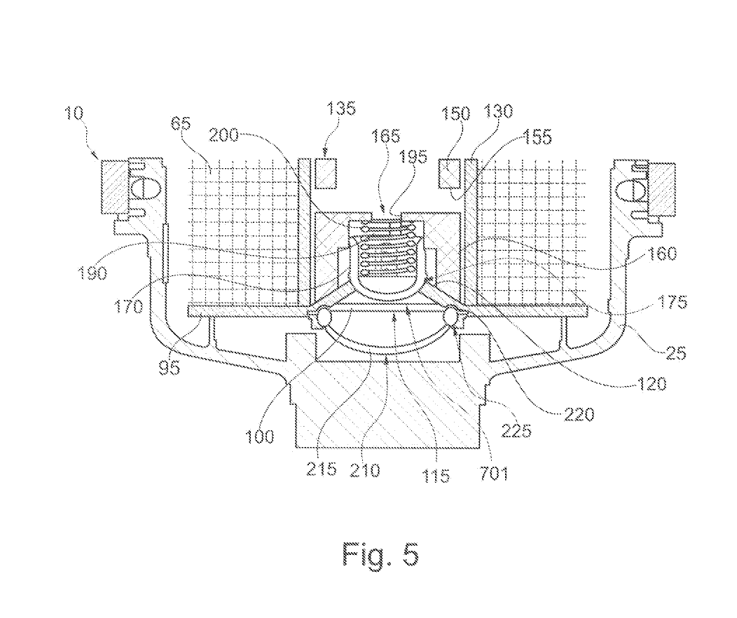

The oil filter 10, as illustrated in FIG. 3, includes an external casing 20, including a beaker-shaped body 25 superiorly closed by a cover 30 on which an oil inlet conduit 35 and an oil outlet conduit 40 are located. In the casing 20 is housed a filter cartridge 60 including a first filter medium 65 having a hollow tubular shape which defines a central conduit 70. The filter cartridge 60 substantially divides an internal volume of the casing 20 into two distinct chambers 75 and 80, of which the first chamber 75 is set in communication with the inlet conduit 35 of the oil to be filtered, and the second chamber 80 is set in communication with the outlet conduit 40 of the filtered oil.

In detail, the first filter medium 65 is provided with an upper plate 85 having a central hole 90 in communication with an end 700 of the conduit 70. The first filter medium 65 is also provided with a lower plate 95 having a central hole 100 in communication with the opposite end 701 of the conduit 70. The lower plate 95 includes also an annular hollow flange 120 protruding upwards from a rim 115 of the central hole 100. A plurality of connecting elements 130 connects the upper plate 85 with the lower plate 95 and they have the function to strengthen the filter cartridge 60. Other embodiments of the filter cartridge may provide for a tubular net connecting the upper plate 85 to the lower plate 95 in place of the plurality of connecting elements 130.

A hollow tubular element 135 is housed in the conduit 70 and it realizes a fluid communication between the conduit 70 and the oil outlet 40 of the oil filter. Indeed an upper end of the tubular element 135 is inserted into the oil outlet 35 extending downwards from the cover 30 while a lower end of the tubular element 135 is externally inserted into the annular hollow flange 120 protruding upwards from the rim 115 of the central hole 100. An upper portion 150 of the hollow tubular element 135 is provided with a plurality of 15 bores 155 allowing the filtered fluid to flow towards the oil outlet 40. A lower portion 160 of the hollow tubular element 135 houses a by-pass valve 165 including a valve member 170 and a valve seat 175 defined by an upper portion 180 (FIG. 4) of the annular hollow flange 120 protruding upwards from the rim 115 of the central hole 100. The valve member 170 is fixed at a free end of a stem 190 slidably inserted into a corresponding seat 195, provided in the tubular element 135, in contrast with the action of a spring 200 acting between the valve member 170 and the seat 195.

According to the disclosed embodiment of the present disclosure, the cartridge 60 includes also a second filter medium 210 which occludes the central conduit 70 intercepting the flowing of oil. In particular the second filter medium 210 includes a cup shaped body 215 which is provided, on an upper edge, with an annular protruding rim 220 housed in a corresponding annular seat 225 of the lower plate 95. In this way the by-pass valve 165 is located downstream the second filter medium 210.

During the operation of the engine the oil is filtered by the first filter medium 65. In detail, the oil flows from the oil inlet 35 and cross the first filter medium 65 from the outside to the inside in the central conduit 70, and in the tubular element 135, and then, it flows towards the oil outlet 40. In case of clogging of the first filter medium 65, or in case of low environment temperature, when the oil increases its viscosity, the oil pressure increases inside the casing.

When the oil pressure value reaches a predetermined value the by-pass valve 165 opens because the force, due to the increasing oil pressure, became greater than the elastic force of the spring 200. In this condition the valve member 170 departs from the valve seat 175 opening the by-pass valve 165 and allowing the flowing of the oil in the tubular element 135 and towards the oil outlet 40 by-passing the first filter medium 65. The oil which flows towards the by-pass valve 165 crosses the second filter medium 210, being the by-pass valve 165 located downstream the second filter medium 210 in the flowing 10 direction towards the oil outlet 40. Hence impurities in the oil are advantageously stopped by the second filter medium 210 avoiding their circulation in the lubricating circuit 9.

The quantity of filtered impurities is greater in an oil filter configuration as disclosed in the present embodiment wherein the by-pass valve 165 is located in region of the casing 20 closed to bottom. This is due to fact that impurities have usually a specific weight greater than the one of the oil, and therefore they tend to accumulate towards the bottom of the casing 20 closed to the by-pass valve 165.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-12. (canceled)

13. A fluid filter cartridge comprising:
a first filter medium having a tubular shape defining a central conduit; and
a second filter medium occludes the central conduit.

14. The fluid filter cartridge according to claim 13, further comprising an upper plate and a lower plate each plate having a central hole, each hole being respectively in communication with an end of the central conduit.

15. The fluid filter cartridge according to claim 14, further comprising a plurality of connecting elements extending between and connecting the lower plate and the upper plate.

16. The fluid filter cartridge according to claim 14, wherein the lower plate comprises an annular flange protruding upwards from a rim of the central hole.

17. The fluid filter cartridge according to claim 13, wherein the second filter medium comprises a cup-shaped body.

18. The fluid filter cartridge according to claim 13, wherein the second filter medium comprises a protruding annular rim housed in an annular seat of the lower plate.

19. A fluid filter for an internal combustion engine comprising:
an external casing having an inlet for a fluid to be filtered and an outlet for a filtered fluid;
a filter cartridge including a first filter medium having a tubular shape defining a central conduit and a second filter medium occluding the central conduit, wherein the filter cartridge divides an internal volume of the casing into a first chamber in fluid communication with the fluid inlet and a second chamber in fluid communication with the fluid outlet; and
a by-pass valve disposed in the central conduit of the filter cartridge downstream of the second filter medium.

20. The fluid filter according to claim 19, wherein the fluid filter cartridge further comprising an upper plate and a lower plate each plate having a central hole, each hole being respectively in communication with an end of the central conduit.

21. The fluid filter according to claim 20, wherein the fluid filter cartridge further comprises a plurality of connecting elements extending between and connecting the lower plate and the upper plate.

22. The fluid filter cartridge according to claim 20, wherein the lower plate comprises an annular flange protruding upwards from a rim of the central hole.

23. The fluid filter cartridge according to claim 19, wherein the second filter medium comprises a cup-shaped body.

24. The fluid filter cartridge according to claim 19, wherein the second filter medium comprises a protruding annular rim housed in an annular seat of the lower plate.

25. The fluid filter according to claim 19, wherein the second chamber houses a hollow tubular element inserted in the central conduit of the filter cartridge.

26. The fluid filter according to claim 20, wherein the hollow tubular element comprises an upper portion provided with a plurality of bores.

27. The fluid filter according to claim 20, wherein the hollow tubular element comprises a lower portion housing the by-pass valve.

28. The fluid filter according to claim 19, wherein the fluid filter cartridge further comprising a lower plate having an annular flange protruding upwards from a rim of a central hole formed therethrough, and wherein the by-pass valve comprises a valve member and a valve seat defined by an upper portion of the annular flange of the lower plate.

29. An internal combustion engine comprising a fluid filter according to claim 19.
